(19) United States
(12) Patent Application Publication
(10) Pub. No.: US 2016/0369021 A1
(43) Pub. Date: Dec. 22, 2016

(54) FLUOROELASTOMERS

(71) Applicant: SOLVAY SPECIALTY POLYMERS ITALY S.P.A., Bollate (MILANO) (IT)

(72) Inventors: Claudia MANZONI, Bologna (IT); Liubov CHERNYSHEVA, Milano (IT); Giovanni COMINO, Monza (IT)

(21) Appl. No.: 14/901,443

(22) PCT Filed: Jun. 24, 2014
(86) PCT No.: PCT/EP2014/063213

§ 371 Date: Dec. 28, 2015

(30) Foreign Application Priority Data
Jun. 28, 2013 (EP) 13174189.4

(51) Int. Cl. C08F 214/22; C08K 3/04; C08K 3/22; C08K 5/14

(52) U.S. Cl. CPC C08F 214/22; C08K 5/14; C08K 3/04; C08K 3/22; C08K 2003/222; C08K 2003/2206

(57) ABSTRACT

The invention pertains to a fluoroelastomer comprising recurring units derived from vinylidene fluoride (VDF), hexa fluoropropylene (HFP); and from 0.1 to 10% by moles of recurring units derived from hexafluoroisobutene (HFIB), wherein the mole percentages are based on the total moles of recurring units.

### CROSS-REFERENCE TO RELATED APPLICATION

This application claims priority to [European or French or other] application No. 13174189.4 filed Jun. 28, 2013, the whole content of this application being incorporated herein by reference for all purposes.

### TECHNICAL FIELD

The invention pertains to certain novel fluoroelastomers comprising recurring units derived from hexafluoroisobutene, to a process for their manufacture, and to cured articles derived therefrom.

### BACKGROUND ART

Fluoroelastomers are a class of high-performance materials with a diverse range of applications ranging from O-rings, valve stem seals, shaft seals, gaskets and fuel hoses in automotive applications to seals and packing for oil wells, further including seals, O-rings and other parts in semi-conductors' manufacturing devices.

Since several years, vinylidene fluoride based fluoroelastomers have indeed established themselves as premium materials in the automotive, chemical petrochemical and electronics industries thanks to their outstanding mechanical properties in a broad temperature operating window and to their un-matched chemical and permeation resistance.

With progressing technologies, expectations for fluoroelastomers based components have continued to grow, for matching needs in even harsher conditions and more demanding performances; a continuous need thus exists for fluoroelastomer parts and seals having improved performances, and more specifically improved mechanical performances.

Diverse approaches have thus been followed for improving mechanical properties of fluoroelastomers, including notably introduction in the polymer backbone chain of recurring units derived from modifying monomers able to confer improved properties.

Hexafluoroisobutene of formula (CF₃)₂C═CH₂ (HFIB, herein after) has been often used in combination with vinylidene fluoride (VDF) to provide highly crystalline materials endowed with outstanding mechanical properties.

Actually, strictly alternate copolymers of VDF and HFIB are known in the art as materials possessing an extremely structured and well packed crystalline habit which confers to this material surprisingly high melting point and crystalline behaviour.

On the other side, HFIB has been only seldom suggested as modifying monomer in elastomeric materials.

U.S. Pat. No. 5,612,419 (AUSIMONT SPA) 18.03.1997 pertains to certain thermoplastic elastomers (TPE) comprising a fluoroelastomer block and a plastomer block; this latter plastomer (semi-crystalline) block can be notably a modified PTFE block comprising recurring units derived from HFIB in an amount of 0.1 to 3%.

U.S. Pat. No. 7,087,679 (DAIKIN INDUSTRIES, LTD) 08.08.2006 discloses certain thermoplastic resin compositions comprising, notably, a fluorine-containing polymer, which can be resinous or elastomeric (see column 10, lines 44 to 47) and which can comprise structural units derived notably from hexafluoroisobutene (see column 5, lines 46 to 49). This fluorine-containing polymer can be notably a resinous or elastomeric VDF polymer comprising at least one additional olefin, CH₂═C(CF₃)₂ being cited among others (column 12, lines 34 to 42).

It has been now found that when modifying certain VDF-based fluoroelastomers compositions by introduction of well-defined amounts of hexafluoroisobutene, modified fluoroelastomers are obtained with significantly improved mechanical properties, in particular Modulus at 100% elongation and Tear Strength, which make them particularly useful for being used in a large variety of technological fields, where improved performances are needed, including in the Oil & Gas applications, in the Automotive field and in the Chemical Industry sector.

### SUMMARY OF INVENTION

The invention thus pertains to a fluoroelastomer [fluoroelastomer (A)] comprising:
from 35 to 85% by moles of recurring units derived from vinylidene fluoride (VDF);
from 10 to 45% by moles of recurring units derived from hexafluoropropylene (HFP); and
from 0.1 to 10% by moles of recurring units derived from hexafluoroisobutene (HFIB),
   wherein the mole percentages are based on the total moles of recurring units.

The Applicant has surprisingly found that by incorporation of above detailed limited amounts of HFIB in fluoroelastomers based on VDF and HFP, as above detailed, it is advantageously possible to increase the mechanical properties of said fluoroelastomer, in particular modulus at 100% elongation, Shore A hardness and tear strength, without significantly impairing sealing properties, and thus maintaining acceptable compression set performances. Incorporation of amounts of HFIB exceeding 10% by moles is not suitable for achieving these goals: beside substantial detrimental effect on polymerization rate, rendering production of highly HFIB fluoroelastomers not advantageous from an industrial perspective, the elongation at break is reduced and the compression set negatively affected.

For the purposes of this invention, the term “fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer). True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Fluoroelastomers (A) are in general amorphous products or products having a low degree of crystallinity (crystalline phase less than 20% by volume) and a glass transition temperature (T_{g}) below room temperature. In most cases, the fluoroelastomer (A) has advantageously a T_{g} below 10° C., preferably below 5° C., more preferably 0° C., even more preferably below −5° C.

Fluoroelastomer (A) typically comprises at least 0.1% moles, preferably at least 1% moles, more preferably at least 2% moles of recurring units derived from HFIB, with respect to all recurring units of the fluoroelastomer.

Fluoroelastomer (A) typically comprises at most 10% moles, preferably at most 9% moles, more preferably at most 8% moles of recurring units derived from HFIB, with respect to all recurring units of the fluoroelastomer.

Particularly good results have been obtained when the fluoroelastomer (A) comprised an amount of recurring units derived from HFIB of 2 to 8% moles, with respect to all recurring units of the fluoroelastomer. Fluoroelastomers (A) possessing this preferred amount of HFIB recurring units can be manufactured in a very effective manner, without HFIB substantially impairing polymerization rate, and provide an optimized compromise of mechanical and sealing properties.

Still, when aiming at optimizing productivity and balance between mechanical and sealing properties, an amount of recurring units derived from HFIB of 2 to 5% moles, with respect to all recurring units of the fluoroelastomer has been found particularly advantageous.

Fluoroelastomer (A) typically comprises at least 35% moles, preferably at least 40% moles, more preferably at least 45% moles of recurring units derived from VDF, with respect to all recurring units of the fluoroelastomer.

Fluoroelastomer (A) typically comprises at most 85% moles, preferably at most 80% moles, more preferably at most 78% moles of recurring units derived from VDF, with respect to all recurring units of the fluoroelastomer.

As per the HFP, fluoroelastomer (A) typically comprises at least 10% moles, preferably at least 12% moles, more preferably at least 15% moles of recurring units derived from HFP, with respect to all recurring units of the fluoroelastomer.

Still, fluoroelastomer (A) typically comprises at most 45% moles, preferably at most 40% moles, more preferably at most 35% moles of recurring units derived from HFP, with respect to all recurring units of the fluoroelastomer.

Fluoroelastomers which have been found to provide particularly good performances are those comprising, in addition to recurring units derived from HFIB, VDF and HFP:
recurring units derived from at least one bis-olefin [bis-olefin (OF)] having general formula:

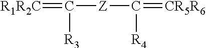

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical;
optionally, recurring units derived from at least one (per)fluorinated monomer different from VDF and HFP; and
optionally, recurring units derived from at least one hydrogenated monomer.

Non limitative examples of suitable (per)fluorinated monomers are notably:

(a) C₂-C₈ perfluoroolefins, such as tetrafluoroethylene (TFE);
(b) hydrogen-containing C₂-C₈ olefins different from VDF, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, e.g. CF₃, C₂F₅, C₃F₇;
(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

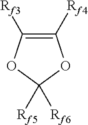

wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;
(g) (per)fluoro-methoxy-vinylethers (MOVE, hereinafter) having formula:

CFX₂═CX₂OCF₂OR″_{f}

wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂═F, H; preferably X₂ is F and R″_{f} is —CF₂CF₃ (MOVE1); —CF₂CF₂OCF₃ (MOVE2); or —CF₃ (MOVE3).

Examples of hydrogenated monomers are notably non-fluorinated alpha-olefins, including ethylene, propylene, 1-butene, diene monomers, styrene monomers, alpha-olefins being typically used. C₂-C₈ non-fluorinated alpha-olefins (01), and more particularly ethylene and propylene, will be selected for achieving increased resistance to bases.

More particularly, those fluoroelastomers (A) which have been found to provide for outstanding performances are those comprising, in addition to recurring units derived from bis-olefin (OF), VDF and HFP:
recurring units derived from tetrafluoroethylene (TFE); and
optionally, recurring units derived from at least one hydrogenated monomer and/or recurring units derived from at least one further (per)fluorinated monomer different from VDF, TFE, and HFP.

Fluoroelastomer (A) of this embodiment typically comprises at least 0.5% moles, preferably at least 1% moles, more preferably at least 5% moles of recurring units derived from TFE, with respect to all recurring units of the fluoroelastomer.

Still, fluoroelastomer (A) of this embodiment typically comprises at most 35% moles, preferably at most 30% moles, more preferably at most 28% moles of recurring units derived from TFE, with respect to all recurring units of the fluoroelastomer.

The bis-olefin (OF) is preferably selected from the group consisting of those complying with formulae (OF-1), (OF-2) and (OF-3):

### (OF-1)

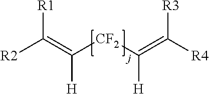

wherein j is an integer between 2 and 10, preferably between 4 and 8, and R1, R2, R3, R4, equal or different from each other, are H, F or C₁₋₅ alkyl or (per)fluoroalkyl group;

### (OF-2)

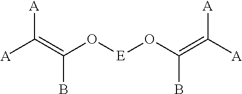

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

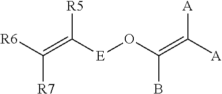

wherein E, A and B have the same meaning as above defined; R5, R6, R7, equal or different from each other, are H, F or C₁₋₅ alkyl or (per)fluoroalkyl group.

While the amount of recurring units derived from bis-olefin (OL) is not particularly limited, for ensuring adequate processability, the amount of said recurring units will be typically of at least 0.01% moles, preferably of at least 0.03% moles and more preferably of at least 0.05% moles, and typically of at most 5.0% moles, preferably at most 0.5% moles, more preferably at most 0.2% moles, with respect to all recurring units of the fluoroelastomer.

Most preferred fluoroelastomers (A) are those having following compositions (in mol %):

(i) hexafluoroisobutene (HFIB) 3-5%; vinylidene fluoride (VDF) 35-85%; hexafluoropropene (HFP) 10-45%; tetrafluoroethylene (TFE) 0-30%; perfluoroalkyl vinyl ethers (PAVE) 0-15%; bis-olefin (OF) 0-5%;
(ii) hexafluoroisobutene (HFIB) 3-5%; vinylidene fluoride (VDF) 35-85%; C₂-C₈ non-fluorinated olefins (OI) 10-30%; hexafluoropropene (HFP) 18-27% (HFP being possibly partially replaced by perfluoroalkyl vinyl ethers (PAVE), in the range 0-15%); tetrafluoroethylene (TFE) 10-30%; bis-olefin (OF) 0-5%;
(iii) hexafluoroisobutene (HFIB) 3-5%; vinylidene fluoride (VDF) 35-85%; (per)fluoromethoxyvinyl ether (MOVE) 5-40%; perfluoroalkyl vinyl ethers (PAVE) 0-30%; tetrafluoroethylene (TFE) 1-35%, hexafluoropropene (HFP) 10-30%; bis-olefin (OF) 0-5%.

According to a first embodiment, fluoroelastomer (A) may advantageously comprise iodine and/or bromine cure sites, in particular when the fluoroelastomer (A) is intended for peroxide curing. Iodine cure sites are those selected for maximizing curing rate.

For ensuring acceptable reactivity it is generally understood that the content of iodine and/or bromine in the fluoroelastomer (A) should be of at least 0.05% wt, preferably of at least 0.1% weight, more preferably of at least 0.15% weight.

On the other side, amounts of iodine and/or bromine not exceeding 2% wt, more specifically not exceeding 1% wt, or even not exceeding 0.5% wt are those generally selected for avoiding side reactions and/or detrimental effects on thermal stability.

All these cure sites might be comprised as pending groups bound to the backbone of the fluoroelastomer polymer chain or might be comprised as terminal groups of said polymer chain.

According to a first variant of this embodiment, the iodine and/or bromine cure sites are comprised as pending groups bound to the backbone of the fluoroelastomer polymer chain; the fluoroelastomer (A) according to this embodiment typically comprises recurring units derived from brominated and/or iodinated cure-site comonomers selected from:
bromo and/or iodo alpha-olefins containing from 2 to 10 carbon atoms such as bromotrifluoroethylene or bromotetrafluorobutene, such as those described, for example, in U.S. Pat. No. 4,035,565 (DUPONT) 12.07.1977 or other compounds bromo and/or iodo alpha-olefins as disclosed in U.S. Pat. No. 4,694,045 (DUPONT) 15.09.1987;
iodo and/or bromo fluoroalkyl vinyl ethers (as notably described in U.S. Pat. No. 4,745,165 (AUSIMONT SPA) 17.05.1988, U.S. Pat. No. 4,564,662 (MINNESOTA MINING) 14.01.1986 and EP 199138 A (DAIKIN IND) 29.10.1986).

The fluoroelastomer (A) according to this variant of this embodiment generally comprises recurring units derived from brominated and/or iodinated cure-site monomers in amounts of 0.05 to 5 moles per 100 moles of all other recurring units of the fluoroelastomer (A), so as to advantageously ensure above mentioned iodine and/or bromine weight content.

According to a second preferred variant of this embodiment, the iodine and/or bromine cure sites are comprised as terminal groups of the fluoroelastomer polymer chain; the fluoroelastomer (A) according to this embodiment is generally obtained by addition to the polymerization medium during fluoroelastomer manufacture of anyone of:
iodinated and/or brominated chain-transfer agent(s). Suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≦x+y≦2 (see, for example, U.S. Pat. No. 4,243,770 (DAIKIN IND LTD) 06.01.1981 and U.S. Pat. No. 4,943,622 (NIPPON MEKTRON KK) 24.07.1990); and
alkali metal or alkaline-earth metal iodides and/or bromides, as described notably in U.S. Pat. No. 5,173,553 (AUSIMONT SRL) 22.12.1992.

According to a second embodiment, fluoroelastomer (A) does not comprise any iodinated and/or brominated cure site; fluoroelastomer (A) according to this second embodiment is particularly intended for ionic curing.

The invention further pertains to a process for manufacturing fluoroelastomer (A) as above described comprising polymerizing a monomer mixture comprising vinylidene fluoride (VDF), hexafluoropropylene (HFP) and hexafluoroisobutene (HFIB) in the presence of a radical initiator.

The monomer mixture will possibly additionally comprise any of the above detailed additional comonomers which may be incorporated into fluoroelastomer (A).

Generally, polymerizing monomer mixture is carried out in aqueous emulsion, in an aqueous phase comprising at least one surfactant, which can be a non fluorinated, a partially fluorinated or a perfluorinated surfactant.

In certain particular embodiments of this aqueous emulsion process, by appropriate choice of surfactant and in combination with a fluorinated compound (e.g. a perfluorinated polyether), a microemulsion can be obtained as polymerization medium.

The aqueous emulsion polymerization may be carried out at a temperature between 10 to 150° C., preferably 20° C. to 110° C. and the pressure is typically between 2 and 30 bar, in particular 5 to 20 bar.

The reaction temperature may be varied during the polymerization e.g. for influencing the molecular weight distribution, i.e., to obtain a broad molecular weight distribution or to obtain a bimodal or multimodal molecular weight distribution.

The pH of the polymerization media may be in the range of pH 2-11, preferably 3-10, most preferably 4-10.

The aqueous emulsion polymerization is typically initiated by a radical initiator including any of the initiators known for initiating a free radical polymerization of fluorinated monomers. Suitable initiators include peroxides and azo compounds and redox based initiators. Specific examples of peroxide initiators include, hydrogen peroxide, sodium or barium peroxide, diacylperoxides such as diacetylperoxide, disuccinyl peroxide, dipropionylperoxide, dibutyrylperoxide, dibenzoylperoxide, benzoylacetylperoxide, diglutaric acid peroxide and dilaurylperoxide, and further per-acids and salts thereof such as e.g. ammonium, sodium or potassium salts. Examples of per-acids include peracetic acid. Esters of the peracid can be used as well and examples thereof include tert.-butylperoxyacetate and tert.-butylperoxypivalate. Examples of inorganic include for example ammonium-alkali- or earth alkali salts of persulfates, permanganic or manganic acid or manganic acids. A persulfate initiator, e.g. ammonium persulfate (APS), can be used on its own or may be used in combination with a reducing agent. Suitable reducing agents include bisulfites such as for example ammonium bisulfite or sodium metabisulfite, thiosulfates such as for example ammonium, potassium or sodium thiosulfate, hydrazines, azodicarboxylates and azodicarboxyldiamide (ADA). Further reducing agents that may be used include sodium formaldehyde sulfoxylate (Rongalit) or fluoroalkyl sulfinates, e.g. as disclosed in U.S. Pat. No. 5,285,002. The reducing agent typically reduces the half-life time of the persulfate initiator. Additionally, a metal salt catalyst such as for example copper, iron or silver salts may be added. The amount of initiator may be between 0.01% by weight (based on the fluoropolymer solids to be produced) and 1% by weight. In one embodiment, the amount of initiator is between 0.05 and 0.5% by weight. In another embodiment, the amount may be between 0.05 and 0.3% by weight.

The aqueous emulsion polymerization can be carried out in the presence of other materials, such as notably buffers and, if desired, complex-formers or chain-transfer agents.

Examples of chain transfer agents that can be used include dimethyl ether, methyl t-butyl ether, alkanes having 1 to 5 carbon atoms such as ethane, propane and n-pentane, halogenated hydrocarbons such as CCl₄, CHCl₃ and CH₂Cl₂ and hydrofluorocarbon compounds such as CH₂F—CF₃ (R134a). Additionally esters like ethylacetate, malonic esters can be effective as chain transfer agent in the process of the invention. As already explained above, when a fluoroelastomer (A) comprising iodine and/or bromine cure site is to be manufactured, brominated and/or iodinated chain transfer agents, as above detailed, will be preferably used.

The fluoroelastomer (A) is advantageously cured by peroxide curing technique, by ionic curing technique or by a mixed peroxidic/ionic technique.

The peroxide curing is typically performed according to known techniques via addition of suitable peroxide that is capable of generating radicals by thermal decomposition. Organic peroxides are generally employed.

Still an object of the invention is thus a peroxide curable composition comprising fluoroelastomer (A) as above detailed and at least one peroxide, typically an organic peroxide.

Among most commonly used peroxides, mention can be made of dialkyl peroxides, for instance di-tert-butyl peroxide, 2,5-dimethyl-2,5-bis(tert-butylperoxy)hexane, bis(1,1-diethylpropyl)peroxide, bis(1-ethyl-1-methylpropyl)peroxide, 1,1-diethylpropyl-1-ethyl-1-methylpropyl-peroxide, 2,5-dimethyl-2,5-bis(tert-amylperoxy)hexane; dicumyl peroxide; dibenzoyl peroxide; di-tert-butyl perbenzoate; bis[1,3-dimethyl-3-(tert-butylperoxy)butyl] carbonate.

Other ingredients generally comprised in the peroxide curable composition, as above detailed, are:

(a) curing coagents, in amounts generally of between 0.5% and 10% and preferably between 1% and 7% by weight relative to the polymer; among these agents, the following are commonly used: triallyl cyanurate; triallyl isocyanurate (TAIC); tris(diallylamine)-s-triazine; triallyl phosphite; N,N-diallylacrylamide; N,N,N′,N′-tetraallylmalonamide; trivinyl isocyanurate; 2,4,6-trivinyl methyltrisiloxane; bis-olefins (OF), as above detailed; triazines substituted with ethylenically unsaturated groups, such as notably those described in EP 860436 A (AUSIMONT SPA) 26.08.1998 and WO 97/05122 (DUPONT) 13.02.1997; among above mentioned curing coagents, TAIC and bis-olefins (OF), as above detailed, and more specifically those of formula (OF-1), as above detailed, have been found to provide particularly good results;
(b) optionally, a metal compound, generally in amounts of between 1 and 15, and preferably between 2 and 10 weight parts per 100 parts of fluoroelastomer (A), typically selected from the group consisting of (i) oxides and hydroxides of divalent metals, for instance Mg, Zn, Ca or Pb, (ii) salts of a weak acid, for instance Ba, Na, K, Pb, Ca stearates, benzoates, carbonates, oxalates or phosphites, and (iii) mixtures of (i) and (ii);
(c) optionally, an acid acceptor of non-metal oxide/hydroxide type, selected from the group consisting of 1,8-bis(dimethylamino)naphthalene, octadecylamine, oxiranes, glycidyl resins obtained by condensation of bisphenol A and epichlorhydrine, organosilances (such as 3-glycidoxypropyl trimethoxy silane);
(d) optionally, other conventional additives, such as reinforcing fillers (e.g. carbon black), thickeners, pigments, antioxidants, stabilizers, processing aids, and the like.

Mixed peroxidic/ionic curing can be achieved by further introducing in the curable composition one or more curing agent and one or more accelerator suitable for ionic curing, as well known in the art.

Ionic curing can be achieved by compounding the fluoroelastomer (A) with at least one curing agent and at least one accelerator. An ionically curable compound comprising fluoroelastomer (A) and at least one curing agent and at least one accelerator is another object of the present invention.

Aromatic or aliphatic polyhydroxylated compounds, or derivatives thereof, may be used as curing agents; examples thereof are described, notably, in EP 335705 A (MINNESOTA MINING) 04.10.1989 and U.S. Pat. No. 4,233,427 (RHONE POULENC IND) 11.11.1980. Among these, mention will be made in particular of dihydroxy, trihydroxy and tetrahydroxy benzenes, naphthalenes or anthracenes; bisphenols, in which the two aromatic rings are linked together via an aliphatic, cycloaliphatic or aromatic divalent radical, or alternatively via an oxygen or sulphur atom, or else a carbonyl group. The aromatic rings may be substituted with one or more chlorine, fluorine or bromine atoms, or with carbonyl, alkyl or acyl groups. Bisphenol AF is particularly preferred.

The amount of accelerator(s) is generally comprised between 0.05 and 5 phr and that of the curing agent typically between 0.5 and 15 phr and preferably between 1 and 6 phr, with respect to the fluoroelastomer (A) weight.

Examples of accelerators that may be used include: quaternary ammonium or phosphonium salts (see, e.g., EP 335705 A (MINNESOTA MINING) 04.10.1989 and U.S. Pat. No. 3,876,654 (DUPONT) 08.04.1975); aminophosphonium salts (see, e.g., U.S. Pat. No. 4,259,463 (MONTEDISON SPA) 31.03.1981); phosphoranes (see, e.g., U.S. Pat. No. 3,752,787 (DUPONT) 14.08.1973); imine compounds of formula [Ar₃P—N═PAr₃]⁺ⁿXⁿ⁻, with Ar being an aryl group, n=1 or 2 and X being a n-valent anion as described in EP 0120462 A (MONTEDISON SPA) 03.10.1984 or of formula [(R₃P)₂N]⁺X⁻, with R being an aryl or an alkyl group, and X being a monovalent anion, e.g. as described in EP 0182299 A (ASAHI CHEMICAL) 28.05.1986. Quaternary phosphonium salts and aminophosphonium salts are preferred.

Instead of using the accelerator and the curing agent separately, it is also possible to use an adduct between an accelerator and a curing agent in a mole ratio of from 1:2 to 1:5 and preferably from 1:3 to 1:5, the accelerator being one of the organic onium compounds having a positive charge, as defined above, and the curing agent being chosen from the compounds indicated above, in particular dihydroxy or polyhydroxy or dithiol or polythiol compounds; the adduct being generally obtained by melting the product of reaction between the accelerator and the curing agent in the indicated mole ratios, or by melting the mixture of the 1:1 adduct supplemented with the curing agent in the indicated amounts. Optionally, an excess of the accelerator, relative to that contained in the adduct, may also be present.

The following are particularly preferred as cations for the preparation of the adduct: 1,1-diphenyl-1-benzyl-N-diethylphosphoranamine and tetrabutylphosphonium; particularly preferred anions are those derived from bisphenol compounds in which the two aromatic rings are bonded via a divalent radical chosen from perfluoroalkyl groups of 3 to 7 carbon atoms, and the OH groups are in the para position. A method suitable for the preparation of an adduct as above described is described in European patent application EP 0684277 A (AUSIMONT SPA) 29.11.1995, which is included herein in its entirety by reference.

Other ingredients generally added to the ionically curable compound comprising fluoroelastomer (A), when curing via ionic route are:

i) one or more mineral acid acceptors chosen from those known in the ionic curing of vinylidene fluoride copolymers, typically comprised in amounts of 1-40 parts per 100 parts of fluoroelastomer (A);
ii) one or more basic compounds chosen from those known in the ionic curing of vinylidene fluoride copolymers, typically added in amounts of from 0.5 to 10 parts per 100 parts of fluoroelastomer (A).

The basic compounds mentioned in point ii) are commonly chosen from the group constituted by Ca(OH)₂, Sr(OH)₂, Ba(OH)₂, metal salts of weak acids, for instance Ca, Sr, Ba, Na and K carbonates, benzoates, oxalates and phosphites and mixtures of the abovementioned hydroxides with the above mentioned metal salts; among the compounds of the type i), mention may be made of divalent metal oxides, including specifically MgO and ZnO or other metal oxides.

The above mentioned amounts of the mixture are relative to 100 phr of fluoroelastomer (A).

Also, other conventional additives, such as reinforcing fillers (e.g. carbon black), thickeners, pigments, antioxidants, stabilizers and the like, may then be added to the ionically curable compound.

The invention also pertains to a method for fabricating shaped articles, comprising using the fluoroelastomer (A) as above described.

The fluoroelastomer (A), generally under the form of a curable compound (a peroxide curable or an ionically curable compound, as above detailed), can be fabricated, e.g. by moulding (injection moulding, extrusion moulding), calendering, or extrusion, into the desired shaped article, which is advantageously subjected to vulcanization (curing) during the processing itself and/or in a subsequent step (post-treatment or post-cure), advantageously transforming the relatively soft, weak, fluoroelastomer (A) into a finished article made of non-tacky, strong, insoluble, chemically and thermally resistant cured fluoroelastomer.

Finally, the invention pertains to cured articles obtained from the fluoroelastomer (A). Said cured articles are generally obtained by moulding and curing the fluoroelastomer (A), and preferably the curable compositions, as above detailed.

The cured articles can be notably pipes, joints, O-ring, hose, and the like.

Should the disclosure of any of the patents, patent applications, and publications that are incorporated herein by reference conflict with the present description to the extent that it might render a term unclear, the present description shall take precedence.

The present invention will be now described in more detail with reference to the following examples, whose purpose is merely illustrative and not limitative of the scope of the invention.

### EXAMPLES

### Preparative Examples

### Example 1

In a 5 litres reactor equipped with a mechanical stirrer operating at 630 rpm, 3.1 l of demineralized water and 23 ml of a microemulsion, previously obtained by mixing 5.5 ml of a perfluoropolyoxyalkylene having acidic end groups of formula: CF₂ClO(CF₂—CF(CF₃)O)ₙ(CF₂O)ₘCF₂COOH, wherein n/m=10, having average molecular weight of 600, 1.4 ml of a 30% v/v NH₄OH aqueous solution, 12.9 ml of demineralised water and 3.2 ml of GALDEN® D02 perfluoropolyether of formula: C—F₋₃−O(CF₂CF(CF₃)O)ₙ(CF₂O)ₘCF₃ with n/m=20, having average molecular weight of 450, were introduced.

Then 1.2 g of 1,4-diiodoperfluorobutane (C₄F₈I₂) as chain transfer agent were introduced, and the reactor was heated and maintained at a set-point temperature of 80° C.; a mixture of tetrafluoroethylene (TFE) (7.5% moles), vinylidene fluoride (VDF) (47.5% moles) and hexafluoropropene (HFP) (45% moles) was then added to reach a final pressure of 26 bar (2.6 MPa). 0.2 g of ammonium persulfate (APS) as initiator were then introduced. Pressure was maintained at set-point of 26 bar by continuous feeding of a gaseous mixture of TFE (11.0% moles), VDF (70.0% moles) and HFP (19.0% moles) up to a total of 1420 g, and 70 g of hexafluoroisobutene (HFIB) in 7 portions of 10 g, starting from the beginning of the polymerization and at 15%, 30%, 45%, 60%, 75% and 90% conversion of gaseous mixture, were also fed to the reactor. Moreover, 5.1 g of CH₂═CH—(CF₂)₆—CH═CH₂, fed in 20 portions each 5% increase in conversion, 4.5 g of C₄F₈I₂ and 0.2 g of APS at 20% conversion, and further 4.1 g of C₄F₈I₂ at 80% conversion were introduced. Then the reactor was cooled, vented and the latex recovered. The latex was coagulated with aluminum sulfate as a coagulation agent, and the polymer separated from the aqueous phase, washed with demineralised water and dried in a convection oven at 90° C. for 16 hours. The composition of the obtained polymer from NMR is summarized in table 1 and the properties in table 3.

### Example 2

Same procedure as detailed in Example 1 was repeated, but 1.6 g of C₄F₈I₂ as chain transfer agent were introduced at the beginning before heating the reactor, pressure was maintained at set-point of 26 bar by continuous feeding of a gaseous mixture of TFE (11.0% moles), VDF (70.0% moles) and HFP (19.0% moles) up to a total of 1360 g, and 140 g of monomer HFIB in 10 portions of 14 g, starting from the beginning of the polymerization and every 10% increase in conversion of gaseous mixture, were fed to the reactor. The composition of the obtained polymer from NMR is summarized in table 1 and the properties in table 3.

### Example 3

Same procedure as detailed in Example 1 was repeated, but 3.3 g of C₄F₈I₂ as chain transfer agent were introduced at the beginning before heating the reactor, pressure was maintained at set-point of 26 bar by continuous feeding of a gaseous mixture of TFE (11.0% moles), VDF (70.0% moles) and HFP (19.0% moles) up to a total of 650 g, and 140 g of monomer HFIB in 5 portions of 28 g, starting from the beginning of the polymerization and every 20% increase in conversion of gaseous mixture, were fed to the reactor. Moreover, 2.5 g of CH₂═CH—(CF₂)₆—CH═CH₂ were fed in 10 portions each 10% increase in conversion, 10.7 g of C₄F₈I₂ and 0.2 g of APS were introduced at 40% conversion, and further 0.2 g of APS were introduced at 80% conversion of gaseous mixture. The composition of the obtained polymer from NMR is summarized in table 1 and the properties in table 3.

### Example 4

### Comparative

In a 5 litres reactor equipped with a mechanical stirrer operating at 630 rpm, 3.1 l of demineralized water and 31 ml of a microemulsion, previously obtained by mixing 7.4 ml of a perfluoropolyoxyalkylene having acidic end groups of formula: CF₂ClO(CF₂—CF(CF₃)O)ₙ(CF₂O)ₘCF₂COOH, wherein n/m=10, having average molecular weight of 600, 1.9 ml of a 30% v/v NH₄OH aqueous solution, 17.4 ml of demineralised water and 4.3 ml of GALDEN® D02 perfluoropolyether of formula: C—F₋₃—O(CF₂CF(CF₃)O)ₙ(CF₂O)ₘCF₃ with n/m=20, having average molecular weight of 450, were introduced.

Then 1.6 g of C₄F₈I₂ as chain transfer agent were introduced, and the reactor was heated and maintained at a set-point temperature of 80° C.; a mixture of TFE (7.5% moles), VDF (47.5% moles) and HFP (45% moles) was then added to reach a final pressure of 26 bar (2.6 MPa). 0.2 g of APS as initiator were then introduced. Pressure was maintained at set-point of 26 bar by continuous feeding of a gaseous mixture of TFE (11.0% moles), VDF (70.0% moles) and HFP (19.0% moles) up to a total of 1350 g. Moreover, 4.7 g of CH₂═CH—(CF₂)₆—CH═CH₂, fed in 20 portions each 5% increase in conversion, 4.5 g of C₄F₈I₂ and 0.2 g of APS at 20% conversion, and further 4.1 g of C₄F₈I₂ at 80% conversion of gaseous mixture were introduced. Then the reactor was cooled, vented and the latex recovered. The latex was coagulated with aluminum sulfate as a coagulation agent, and the polymer separated from the aqueous phase, washed with demineralised water and dried in a convection oven at 90° C. for 16 hours. The composition of the obtained polymer from NMR is summarized in table 1 and the properties in table 3.

### Example 5

In a 5 litres reactor equipped with a mechanical stirrer operating at 630 rpm, 3.1 l of demineralized water were introduced.

Then the reactor was heated and maintained at a set-point temperature of 85° C.; a mixture of VDF (53.0% moles) and HFP (47.0% moles) was then added to reach a final pressure of 20 bar (2.0 MPa). 5.9 g of APS as initiator were then introduced. Pressure was maintained at set-point of 20 bar by continuous feeding of a gaseous mixture of VDF (78.5% moles) and HFP (21.5% moles) up to a total of 1350 g, and 70 g of HFIB in 7 portions of 10 g, starting from the beginning of the polymerization and at 15%, 29%, 43%, 58%, 72% and 86% conversion of gaseous mixture, were also fed to the reactor. Moreover, 14 g of ethylacetate as chain transfer agent were fed to the reactor according to the following procedure: 0.6 g at 15% conversion, 0.8 g at 24% conversion, 1.1 g at 32% conversion, 1.2 g at 41% conversion, 1.4 g at 49% conversion, 1.5 g at 58% conversion, 1.7 g at 66% conversion, 1.8 g at 75% conversion, 1.9 g at 83% conversion, 2 g at 91%. Then the reactor was cooled, vented and the latex recovered. The latex was coagulated with aluminum sulfate as a coagulation agent, and the polymer separated from the aqueous phase, washed with demineralised water and dried in a convection oven at 90° C. for 16 hours. The composition of the obtained polymer from NMR is summarized in table 2 and the properties in table 4.

### Example 6

Same procedure as detailed in Example 5 was repeated, but 140 g of monomer HFIB in 7 portions of 20 g at the same conversions as per Example 5 were fed to the reactor. The composition of the obtained polymer from NMR is summarized in table 2 and the properties in table 4.

### Example 7

Same procedure as detailed in Example 5 was repeated, but pressure was maintained at set-point of 20 bar by continuous feeding of a gaseous mixture of VDF (78.5% moles) and HFP (21.5% moles) up to a total of 800 g, and 177 g of HFIB in 15 steps starting from the beginning of the polymerization and at 15%, 24%, 29%, 32%, 41%, 43%, 49%, 58%, 66%, 72%, 75%, 83%, 86% and 91% conversion of gaseous mixture, were also fed to the reactor. Moreover, 12.5 g of ethylacetate as chain transfer agent were fed to the reactor according to the following procedure: 0.5 g at 15% conversion, 0.7 g at 24% conversion, 0.9 g at 32% conversion, 1.1 g at 41% conversion, 1.2 g at 49% conversion, 1.4 g at 58% conversion, 1.5 g at 66% conversion, 1.6 g at 75% conversion, 1.7 g at 83% conversion, 1.9 g at 91% conversion. The composition of the obtained polymer from NMR is summarized in table 2 and the properties in table 4.

### Example 8

### Comparative

Same procedure as detailed in Example 5 was repeated, but no HFIB was fed to the reactor. The composition of the obtained polymer from NMR is summarized in table 2 and the properties in table 4.

TABLE 1

| % moles | VDF | HFP | TFE | HFIB |
|---|---|---|---|---|
| Ex. 1 | 71.1 | 17.8 | 8.8 | 2.3 |
| Ex. 2 | 70.8 | 17.2 | 8.0 | 4.0 |
| Ex. 3 | 70.6 | 15.4 | 7.4 | (*) |
| Ex. 4C | 71.2 | 17.7 | 11.1 | — |

(*) Estimated HFIB content from NMR: about 8% moles

TABLE 2

| % moles | VDF | HFP | HFIB |
|---|---|---|---|
| Ex. 5 | 75.3 | 22.4 | 2.3 |
| Ex. 6 | 74.6 | 22.8 | (**) |
| Ex. 7 | 71.3 | 20.9 | 7.8 |
| Ex. 8C | 78.9 | 21.1 | — |

(**) Estimated HFIB content from NMR: about 4% moles

### Mechanical and Chemical Resistance Property Determination on Cured Samples

Fluoroelastomers were compounded with the additives as detailed in following table in a open mill. Mooney viscosity (ML) (1+10@121° C.) was determined according to ASTM D1646 for both bare fluoroelastomer and curable compound. Plaques and O-rings (size class=214) have been cured in a pressed mould and then post-treated in an air circulating oven in conditions (time, temperature) below specified.

The tensile properties have been determined on specimens punched out from the plaques, according to the DIN 53504 S2 Standard.

M 50 is the tensile strength in MPa at an elongation of 50%
M 100 is the tensile strength in MPa at an elongation of 100%
T.S. is the tensile strength in MPa;
E.B. is the elongation at break in %.

The Shore A hardness (3″) (HDS) has been determined on 3 pieces of plaque piled according to the ASTM D 2240 method.

The compression set (C-SET) has been determined on O-ring, spaceman standard AS568A (type 214) or on 6 mm buttons (type 2), according to the ASTM D 395, method B.

Cure behaviour was characterized by Moving Die Rheometer (MDR), in conditions as specified below, by determining the following properties:

M_{L}=Minimum torque (lb×in)
M_{H}=Maximum torque (lb×in)
t_{S2}=Scorch time, time for two units rise from M_{L} (sec);
t′₉₀=Time to 90% state of cure (sec).

Chemical resistance was evaluated according ASTM D471 standard; more precisely, by performing a IRM903 test at 23° C. during 70 h with methanol.

Results are summarized in the following tables.

TABLE 3

| | | | | |
|---|---|---|---|---|
| Run | 1 | 2 | 3 | 4C |

Elastomer

| | | | | | |
|---|---|---|---|---|---|
| From Ex. 1 | phr | 100 | | | |
| From Ex. 2 | phr | | 100 | | |
| From Ex. 3 | phr | | | 100 | |
| From Ex. 4C | phr | | | | 100 |

Other ingredients

| | | | | | |
|---|---|---|---|---|---|
| TAIC(*) | phr | 4 | 4 | 4 | 4 |
| Peroxide(**) | phr | 3 | 3 | 3 | 3 |
| ZnO(***) | phr | 5 | 5 | 5 | 5 |
| Carbon black (*v) | phr | 30 | 30 | 30 | 30 |

Mooney Viscosity (ML 1 + 10 at 121° C.)

| | | | | | |
|---|---|---|---|---|---|
| Raw elastomer | ML | 60 | 47 | 53 | 50 |
| Compound | ML | 64 | 51 | 55 | 53 |

MDR curing 12 min at 170° C.

| | | | | | |
|---|---|---|---|---|---|
| M_{L} | lb × in | 1.3 | 1.3 | 2.7 | 1.1 |
| M_{H} | lb × in | 24.5 | 26.1 | 44.3 | 26.9 |
| t_{S2} | s | 32 | 31 | 28 | 31 |
| t′₉₀ | s | 80 | 73 | 83 | 74 |

Molding: t′₉₀ at 150° C.
Post cure: (1 + 4) h at 230° C.
Mechanical Properties at room temperature (23° C.)

| | | | | | |
|---|---|---|---|---|---|
| Tensile Strength | MPa | 21.3 | 22.7 | 26.6 | 21.6 |
| 100% Modulus | MPa | 5.9 | 8.3 | 19.5 | 5.1 |
| Elongation @ Break | % | 252 | 243 | 153 | 275 |
| Hardness (Shore A) | pts | 73 | 78 | 93 | 71 |

Sealing properties

| | | | | | |
|---|---|---|---|---|---|
| C-set 70 h at 200° C. | % | 29.5 | 25.7 | 28.7 | 26.9 |

Tear Resistance at 23° C.

| | | | | | |
|---|---|---|---|---|---|
| Tear Strength | N/mm | 37.0 | 41.9 | 56.9 | 33.1 |

Chemical Resistance in methanol (70 h at 23° C.)

| | | | | | |
|---|---|---|---|---|---|
| Δ Volume | % | n.d. | +46 | n.d. | +83 |

(*)Crosslinking agent: Drimix ® TAIC 75 supported (triallyl isocyanurate 75% supported on synthetic calcium silicate)
(**)Catalyst agent: LUPEROX ® 101 XL 45 from Atofina, ~45% 2,5-dimethyl-2,5-di(t-butylperoxy)hexane (C₁₆H₃₄O₄) on calcium carbonate/silica;
(***)from Carlo Erba;
(*v) Reinforcing filler Carbon black N990MT from Cancarb.

TABLE 4

| | | | | |
|---|---|---|---|---|
| Run | 1 | 2 | 3 | 4C |

Elastomer

| | | | | | |
|---|---|---|---|---|---|
| From Ex. 5 | phr | 100 | | | |
| From Ex. 6 | phr | | 100 | | |
| From Ex. 7 | phr | | | 100 | |
| From Ex. 8C | phr | | | | 100 |

Other ingredients

| | | | | | |
|---|---|---|---|---|---|
| Curative V5(*) | phr | 3 | 3 | 3 | 3 |
| MgO(**) | phr | 3 | 3 | 3 | 3 |
| Ca(OH)₂(***) | phr | 6 | 6 | 6 | 6 |
| Carbon black (*v) | phr | 30 | 30 | 30 | 30 |

Mooney Viscosity (ML 1 + 10 at 121° C.)

| | | | | | |
|---|---|---|---|---|---|
| Raw elastomer | ML | 34 | 42 | 35 | 28 |
| Compound | ML | 58 | 68 | 57 | 53 |

MDR curing 6 min at 177° C.

| | | | | | |
|---|---|---|---|---|---|
| M_{L} | lb × in | 0.9 | 1.4 | 1.4 | 0.7 |
| M_{H} | lb × in | 24.4 | 30.8 | 23.6 | 21.8 |
| t_{S2} | s | 140 | 155 | 262 | 130 |
| t′₉₀ | s | 221 | 251 | 332 | 202 |

Molding: 6 min at 180° C.
Post cure: (8 + 16) h at 250° C.
Mechanical Properties at room temperature (23° C.)

| | | | | | |
|---|---|---|---|---|---|
| Tensile Strength | MPa | 17.4 | 12.9 | 19.1 | 13.8 |
| 100% Modulus | MPa | 8.0 | 11.4 | 17.3 | 5.9 |
| Elongation @ Break | % | 192 | 113 | 115 | 187 |
| Hardness (Shore A) | pts | 82 | 91 | 97 | 76 |

Sealing properties

| | | | | | |
|---|---|---|---|---|---|
| C-set 70 h at 200° C. | % | 19.0 | 22.0 | 39.0 | 15.0 |

(*)Benzyltriphenylphosphonium bisphenol AF salt commercially available from Lianyungang TetraFluor New Materials Co., Ltd.;
(**)MAGLITE ® DE high surface area, high activity magnesium oxide from Merck;
(***)Rhenofit ® CF (GE 1890) calcium hydroxide from Rhein Chemie;
(*v) Reinforcing filler Carbon black N990MT from Cancarb.

1. A fluoroelastomer (A) comprising:
from 35 to 85% by moles of recurring units derived from vinylidene fluoride (VDF);
from 10 to 45% by moles of recurring units derived from hexafluoropropylene (HFP); and
from 0.1 to 10% by moles of recurring units derived from hexafluoroisobutene (HFIB),
wherein the mole percentages are based on the total moles of recurring units.

2. The fluoroelastomer (A) of claim 1, comprising at least 1% moles of recurring units derived from HFIB, with respect to all recurring units of the fluoroelastomer and/or comprising at most 9% moles of recurring units derived from HFIB, with respect to all recurring units of said fluoroelastomer (A).

3. The fluoroelastomer (A) of claim 1, comprising at least 40% moles of recurring units derived from VDF, with respect to all recurring units of the fluoroelastomer (A) and/or comprising at most 80% moles of recurring units derived from VDF, with respect to all recurring units of the fluoroelastomer (A).

4. The fluoroelastomer (A) of claim 1, comprising at least 12% moles of recurring units derived from HFP, with respect to all recurring units of the fluoroelastomer (A) and/or comprising at most 40% moles of recurring units derived from HFP, with respect to all recurring units of the fluoroelastomer (A).

5. The fluoroelastomer (A) according to claim 1, further comprising:
recurring units derived from at least one bis-olefin (OF) having general formula: 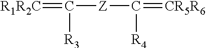
wherein R₁, R₂, R₃, R₄, R₅ and R₆, equal or different from each other, are H, a halogen, or a C₁-C₅ optionally halogenated group, optionally comprising one or more oxygen group; Z is a linear or branched C₁-C₁₈ optionally halogenated alkylene or cycloalkylene radical, optionally containing oxygen atoms, or a (per)fluoropolyoxyalkylene radical;
optionally, recurring units derived from at least one (per)fluorinated monomer different from VDF and HFP; and
optionally, recurring units derived from at least one hydrogenated monomer, wherein the amount of recurring units derived from said bis-olefin (OF) is of at least 0.01% moles and/or of at most 5.0% moles with respect to all recurring units of the fluoroelastomer (A).

6. The fluoroelastomer (A) of claim 1, comprising recurring units derived from at least one (per)fluorinated monomer different from VDF and HFP, said (per)fluorinated monomer being selected from the group consisting of:
(a) C₂-C₈ perfluoroolefins,
(b) hydrogen-containing C₂-C₈ olefins different from VDF, or perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins;
(d) (per)fluoroalkylvinylethers (PAVE) of formula CF₂═CFOR_{f}, wherein R_{f} is a C₁-C₆ (per)fluoroalkyl group;
(e) (per)fluoro-oxy-alkylvinylethers of formula CF₂═CFOX, wherein X is a C₁-C₁₂ ((per)fluoro)-oxyalkyl comprising catenary oxygen atoms;
(f) (per)fluorodioxoles having formula: 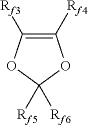
wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom;
(g) (per)fluoro-methoxy-vinylethers (MOVE, hereinafter) having formula:
CFX₂═CX₂OCF₂OR″_{f}
wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂ is selected from F and H

7. The fluoroelastomer (A) according to claim 5, further comprising:
recurring units derived from tetrafluoroethylene (TFE); and
optionally, recurring units derived from at least one hydrogenated monomer and/or recurring units derived from at least one further (per)fluorinated monomer different from VDF, TFE, and HFP,
said fluoroelastomer (A) comprising at least 0.5% moles of recurring units derived from TFE, with respect to all recurring units of the fluoroelastomer (A) and/or comprising at most 35% moles of recurring units derived from TFE, with respect to all recurring units of the fluoroelastomer (A).

8. The fluoroelastomer (A) of claim 5, wherein said bis-olefin (OF) is selected from the group consisting of those complying with formulae (OF-1), (OF-2) and (OF-3): 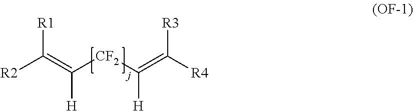
wherein j is an integer between 2 and 10, and R1, R2, R3, R4, equal or different from each other, are H, F, C₁₋₅ alkyl or a (per)fluoroalkyl group; 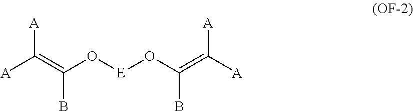
wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; 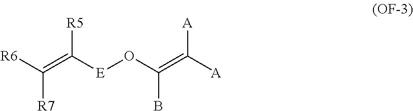
wherein E, A and B have the same meaning as above defined; and R5, R6, R7, equal or different from each other, are H, F, C₁₋₅ alkyl or a (per)fluoroalkyl group.

9. The fluoroelastomer (A) according to claim 1, having one of following compositions (in mol %):
(i) hexafluoroisobutene (HFIB) 3-5%; vinylidene fluoride (VDF) 35-85%; hexafluoropropene (HFP) 10-45%; tetrafluoroethylene (TFE) 0-30%; perfluoroalkyl vinyl ethers (PAVE) 0-15%; bis-olefin (OF) 0-5%;
(ii) hexafluoroisobutene (HFIB) 3-5%; vinylidene fluoride (VDF) 35-85%; C₂-C₈ non-fluorinated olefins (01) 10-30%; hexafluoropropene (HFP) 18-27% (HFP being optionally partially replaced by perfluoroalkyl vinyl ethers (PAVE), in the range 0-15%); tetrafluoroethylene (TFE) 10-30%; bis-olefin (OF) 0-5%; or
(iii) hexafluoroisobutene (HFIB) 3-5%; vinylidene fluoride (VDF) 35-85%; (per)fluoromethoxyvinyl ether (MOVE) 5-40%; perfluoroalkyl vinyl ethers (PAVE) 0-30%; tetrafluoroethylene (TFE) 1-35%, hexafluoropropene (HFP) 10-30%; bis-olefin (OF) 0-5%.

10. A process for manufacturing fluoroelastomer (A) according to claim 1, the process comprising polymerizing a monomer mixture comprising vinylidene fluoride (VDF), hexafluoropropylene (HFP) and hexafluoroisobutene (HFIB) in the presence of a radical initiator.

11. A peroxide curable composition comprising fluoroelastomer (A) according to claim 1, and at least one peroxide, and further optionally comprising one or more than one of the following ingredients:
(a) curing coagents, in amounts of between 0.5% and 10% by weight relative to the polymer, said curing coagents being selected from the group consisting of triallyl cyanurate; triallyl isocyanurate (TAIC); tris(diallylamine)-s-triazine; triallyl phosphite; N,N-diallylacrylamide; N,N,N′,N′-tetraallylmalonamide; trivinyl isocyanurate; 2,4,6-trivinyl methyltrisiloxane; bis-olefins (OF), as defined in claim 5; and triazines substituted with ethylenically unsaturated groups;
(b) a metal compound, in amounts of between 1 and 15 weight parts per 100 parts of fluoroelastomer (A), selected from the group consisting of (i) oxides and hydroxides of divalent metals, (ii) salts of a weak acid, and (iii) mixtures of (i) and (ii);
(c) an acid acceptor of non-metal oxide/hydroxide type, selected from the group consisting of 1,8-bis(dimethylamino)naphthalene, octadecylamine, oxiranes, glycidyl resins obtained by condensation of bisphenol A and epichlorhydrine, and organosilanes; and
(d) other conventional additives, selected from the group consisting of reinforcing fillers, thickeners, pigments, antioxidants, stabilizers, and processing aids.

12. An ionically curable compound comprising the fluoroelastomer (A) according to claim 1, and further comprising:
at least one curing agent selected from the group consisting of aromatic or aliphatic polyhydroxylated compounds, and derivatives thereof; and
at least one accelerator selected from the group consisting of quaternary ammonium or phosphonium salts; aminophosphonium salts; phosphoranes; and imine compounds of formula [Ar₃P—N═PAr₃]⁺ⁿXⁿ⁻, with Ar being an aryl group, n=1 or 2 and X being a n-valent anion or of formula [(R₃P)₂N]⁺X⁻, with R being an aryl or an alkyl group, and X being a monovalent anion.

13. A method for fabricating shaped articles, the method comprising moulding, calendering, or extruding the fluoroelastomer (A) according to claim 1, such that a shaped article is fabricated.

14. The method of claim 13, further comprising vulcanizing the shaped article during the processing itself and/or in a subsequent step.

15. A cured article obtained by moulding and curing the curable composition of claim 11, wherein said cured article is at least one article selected from pipes, joints, O-rings, and hoses.

16. The fluoroelastomer (A) of claim 2, comprising between 2% and 8% by moles of recurring units derived from HFIB, with respect to all recurring units of fluoroelastomer (A).

17. The fluoroelastomer (A) of claim 3, comprising between 45% and 78% by moles of recurring units derived from VDF, with respect to all recurring units of fluoroelastomer (A).

18. The fluoroelastomer (A) of claim 4, comprising between 15% and 35% by moles of recurring units derived from HFP, with respect to all recurring units of the fluoroelastomer (A).

19. The fluoroelastomer (A) of claim 1, comprising:
between 2% and 8% by moles of recurring units derived from HFIB;
between 45% and 78% by moles of recurring units derived from VDF; and
between 15% and 35% by moles of recurring units derived from HFP, with respect to all recurring units of the fluoroelastomer (A).

20. The fluoroelastomer (A) of claim 6, wherein said (per)fluorinated monomer is selected from the group consisting of tetrafluoroethylene (TFE); vinyl fluoride (VF); trifluoroethylene (TrFE); chlorotrifluoroethylene (CTFE); (per)fluoroalkylvinylethers (PAVE) of formula CF₂═CFOR_{f}, wherein R_{f} is selected from CF₃, C₂F₅, C₃F₇; (per)fluoro-oxy-alkylvinylethers of formula CF₂═CFOX, wherein X is perfluoro-2-propoxypropyl; (per)fluorodioxoles having formula: 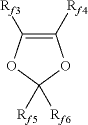
wherein R_{f3}, R_{f4}, R_{f5}, R_{f6}, equal or different from each other, are independently selected from —CF₃, —OCF₃, and —OCF₂CF₂OCF₃; and (per)fluoro-methoxy-vinylethers (MOVE) having formula:
CFX₂═CX₂OCF₂OR″_{f}
wherein R″_{f} is selected from —CF₂CF₃, —CF₂CF₂OCF₃, and —CF₃, and X₂ is F.
